(19) United States
(12) Patent Application Publication
(10) Pub. No.: US 2026/0264776 A1
(43) Pub. Date: Sep. 10, 2026

(54) FIFTH WHEEL LOCKING COUPLER

(71) Applicant: Jost International Corp., Grand Haven, MI (US)

(72) Inventors: Brian J. Hart, Holland, MI (US); Jeremiah D. Hawk, Greeneville, TN (US); Addison S. Karnes, Johnson City, TN (US); William R. Knight, JR., Greeneville, TN (US); Israel T. Hildebrandt, Nunica, MI (US)

(21) Appl. No.: 19/075,250

(22) Filed: Mar. 10, 2025

(51) Int. Cl. B62D 53/10

(52) U.S. Cl. CPC B62D 53/10

(57) ABSTRACT

A fifth wheel can include a pivot lock that is moveable to selectively engage a latch plate at distinct contact points corresponding to locked and unlocked modes of the fifth wheel. The pivot lock can be pivotally joined with an actuator bar and/or a lever connected to a lock bar holding a kingpin of a trailer. The pivot lock can include a first tooth that engages a latch plate first catch to maintain the locked mode holding the kingpin. The latch plate can include a reset catch. The pivot lock can be moved by biasing members, a manual actuator bar and/or the lever. When moved, a second tooth of the pivot lock can selectively engage the reset catch to attain the unlocked mode for kingpin removal. The second tooth can be disengaged from the reset catch via movement of the lever to return to the locked mode.

### BACKGROUND OF THE INVENTION

The present invention relates to a tractor-trailer fifth wheel for connecting a tractor to a trailer, and more particularly to locking mechanisms for fifth wheels.

In the commercial trucking industry, semi-trailer systems are used in which a tractor is coupled to a load carrying trailer for transportation of loads over a road. Fifth wheels are a type of towing setup used primarily for heavy-duty semi-trailer systems, distinguished by their hitching mechanism that involves a specific coupling system. Fifth wheel systems use a large, U-shaped coupling mounted on the chassis of a semi-truck that attaches to a specialized hitch, or a kingpin, connected to the trailer. This setup provides greater stability and weight distribution, making fifth wheels ideal for hauling large trailers with a higher center of gravity. Originating in the early 20th century, the fifth wheel design has evolved to enhance towing safety and ease of use, allowing for smoother tractor rides and better maneuverability compared to other hitch types. The fifth wheel design facilitates ease of use for the operator and increases the robustness of the coupling.

In recent years, to further enhance the security and reliability of fifth wheels, secondary locking mechanisms for fifth wheels have been developed. Secondary locking mechanisms in fifth wheels are crucial safety features designed to ensure the secure attachment of the trailer to the towing vehicle. These mechanisms typically operate in conjunction with a primary locking system, which uses a U-shaped coupling to connect the tractor to the hitch mounted on the trailer. The secondary lock is often a manual or automatic device that engages once the primary lock is secured, providing an additional layer of protection against accidental disengagement. Common examples include a locking pin or a sliding bar that locks the fifth wheel in place, preventing any lateral or vertical movement between the trailer and the truck. This redundancy enhances safety by reducing the risk of trailer detachment, especially during rigorous driving conditions or while maneuvering.

Generally, these secondary locking mechanisms operate by having a latch selectively interface with a notch or protrusion disposed within the body of the fifth wheel. The secondary locking mechanisms are generally disposed at the intersection of a handle that a user moves to unlock or lock the fifth wheel and a lever that translates the movement of the handle to a primary locking mechanism or “jaw” that retains the kingpin within the fifth wheel. However, these secondary locking mechanisms can be cumbersome to lock and unlock, and issues with spontaneous unlocking during rough driving conditions persist.

Accordingly, there remains room for improvement in the field of fifth wheels, and in particular for systems and components to facilitate effective locking and unlocking of fifth wheels, while preventing spontaneous unlocking.

### SUMMARY OF THE INVENTION

A fifth wheel is provided including a pivot lock that is moveable to selectively engage a latch plate at distinct contact points corresponding to locked and unlocked modes of the fifth wheel to thereby respectively secure a kingpin of a trailer to the fifth wheel for transit and to release the kingpin of the trailer to disconnect the trailer from the fifth wheel and an associated tractor, semi, truck or other vehicle.

In one embodiment, the fifth wheel can include a top plate defining a throat configured to receive the kingpin, a lock bar slidable between a closed position where the lock bar blocks removal of the kingpin from the throat and an open position permitting removal of the kingpin from the throat and a lever rotatably joined with the lock bar.

In another embodiment, the pivot lock can include a pivot lock first tooth and a pivot lock second tooth distal from one another and the pivot lock pivot. The pivot lock can be rotatably joined with an actuator bar and/or the lever connected to a lock bar configured to hold the kingpin.

In still another embodiment, the latch plate can be disposed in proximity to the pivot lock. The latch plate can include a first catch, and a reset catch distal from the first catch. The pivot lock first tooth and pivot lock second tooth can be distal from the lever and can protrude toward the latch plate so that during movement of the pivot lock relative to the latch plate, the pivot lock can toggle about the pivot lock axis, with the first tooth and second tooth riding along a path over and/or adjacent, and in some cases engaging, the first catch and/or the reset catch in different modes.

In yet another embodiment, the pivot lock is operable in a locked mode in which the pivot lock first tooth engages the first catch thereby preventing rotation of the lever and thus securing the lock bar in the closed position. In the closed position, the lock bar blocks removal of the kingpin from the throat.

In even another embodiment, the pivot lock is operable in an unlocked mode in which the pivot lock second tooth engages the reset catch to hold the lever in a position and thus maintain the lock bar in the open position. In the open position, the kingpin is removable from the throat to decouple the trailer from the fifth wheel. Another kingpin of another trailer can be installed in the throat to couple the other trailer to the fifth wheel in the open position.

In a further embodiment, the pivot lock can be moved directly or indirectly via one or more biasing members. A first biasing member can be rotatably joined with the pivot lock at an actuator pivot. The first biasing member can be configured to urge the pivot lock to move along the latch plate as the first biasing member moves the lever to transition the lock bar from the open position to the closed position.

In still a further embodiment, the pivot lock first tooth moves over the first catch and the reset catch of the latch plate as the pivot lock moves along the latch plate from the closed position to the open position.

In yet a further embodiment, the pivot lock first tooth moves over the reset catch and the first catch of the latch plate as the pivot lock moves along the latch plate from the open position to the closed position.

In even a further embodiment, the pivot lock can be moved by an actuator bar that is manually moveable. The actuator bar can be rotatably joined with the pivot lock at the actuator pivot. The manual actuator can be actuated to disengage the first tooth from the first catch to begin progression to the unlocked mode.

In a further embodiment, the first biasing member can be an air cylinder that can be pressurized or not. When pressurized, the first biasing member can toggle or rotate the pivot lock about the pivot lock axis such that when the actuator bar is engaged to disengage the first tooth from the first catch, the first tooth can clear the first catch and move along the latch plate along a first path toward the reset catch of the latch plate. This can in turn allow the lever to rotate relative to the lock bar about a lever pivot and can enable the lever to move the lock bar toward the open position.

In still a further embodiment, the first biasing member can move the pivot lock such that the first tooth and a second tooth pass beyond a reset catch along the first path. The first biasing element can be deactivated in an inactive mode so that it no longer urges the pivot lock along the first path.

In yet a further embodiment, the fifth wheel can include a second biasing member, which can be configured to urge the pivot lock and its teeth along a second path, opposite the first path. The second biasing member can be joined with the lever and/or or the pivot lock. The second biasing member can urge the pivot lock along the second path after the first biasing element is in the inactive mode. In this condition, the second biasing member can urge the pivot lock second tooth to engage the reset catch to hold the lever in a position and thus maintain the lock bar in the open position. In the open position, the kingpin can be removed from the throat and the fifth wheel.

In even a further embodiment, the pivot lock can include a first stop and the lever can include a first limiter. The first stop can engage the first limiter when the pivot lock second tooth engages the reset catch such that the pivot lock is impaired from rotating about the pivot lock axis. In this condition, the pivot lock and the lever are held in a static mode relative to one another so the lever cannot rotate or move the lock bar.

In another embodiment, the kingpin can be removed from the throat past the lock bar, causing a lock jaw in the throat of the fifth wheel to engage the lock bar, thereby moving the lever joined with the pivot lock to thereby disengage the second tooth from the reset catch. The lock jaw maintains the pivot lock in this condition, such that the second tooth is cleared of the reset catch after removal of the kingpin and as another kingpin of another trailer enters the throat and lock jaw, thereby moving the lock bar and lever again so that the second biasing member can urge the pivot lock and its teeth along the second path.

In still another embodiment, the pivot lock can include a second stop and the lever can include a second limiter aligned with the second stop. A pivot lock biasing member can be joined between the pivot lock and the lever. The pivot lock biasing member can urge the second stop to engage the second limiter to urge the pivot lock into a reset catch clearance mode in which the pivot lock second tooth clears the reset catch thereby allowing the pivot lock second tooth to travel toward the first catch adjacent the latch plate along the second path.

In yet another embodiment, the second biasing member can move the second tooth over the first catch. The outside face of the first catch can be ramped so that the second tooth and first tooth ride over or past the ramped face to pass the first along the second path, such that the first tooth and second tooth are disposed between the first catch and the first biasing member. With the first tooth behind the first catch, the lock bar can be maintained in the locked position.

In even another embodiment, the latch plate can include a safety latch. The second tooth can engage the safety catch when the draw bar load pulling on the lock bar causes the lock bar to squirt away from the throat, thereby causing the lever to rotate and thus the pivot lock to move, potentially disengaging or moving the pivot lock first tooth away from the first catch, especially if the pivot lock biasing member malfunctions or fails. The second tooth can ride along the latch to engage the safety catch, thereby preventing the first tooth pivot lock generally from clearing the first catch so that the first catch continues to obstruct movement of the first tooth toward the reset catch along or adjacent the latch plate.

The current embodiments provide a fifth wheel locking coupler that provides for a safe and efficient locking of the kingpin relative to the fifth wheel. The locking coupler also can enable easy and rapid disconnection of the kingpin from the fifth wheel, along with several fail safes to prevent inadvertent disconnection of the kingpin from the fifth wheel.

These and other objects, advantages, and features of the invention will be more fully understood and appreciated by reference to the description of the current embodiment and the drawings.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWINGS

FIG. 1A is a bottom view of a fifth wheel of a current embodiment with a lock bar in a locked position to secure a first kingpin relative to the fifth wheel.

FIG. 1B is a close-up bottom view of FIG. 1A, depicting the interface between a pivot lock and a latch plate.

FIG. 2A is a bottom view of the fifth wheel with a first biasing member initially disengaging a pivot lock and a first tooth thereof from a first catch of a latch plate via a first biasing member rotating the first tooth for movement along a first path.

FIG. 2B is a close-up bottom view of FIG. 2A, depicting the interface between a pivot lock and a latch plate.

FIG. 3A is a bottom view of the fifth wheel with the first biasing member continuing to hold the first tooth to clear the first latch as the first tooth moves along the first path toward the reset catch under force of the first biasing member.

FIG. 3B is a close-up bottom view of FIG. 3A, depicting the interface between a pivot lock and a latch plate.

FIG. 4A is a bottom view of the fifth wheel with the first biasing member continuing to hold the first tooth to clear the first latch as the first tooth moves along the first path toward the reset catch under force of the first biasing member.

FIG. 4B is a close-up bottom view of FIG. 4A, depicting the interface between a pivot lock and a latch plate.

FIG. 5A is a bottom view of the fifth wheel with the first biasing member continuing to hold the first tooth and pivot lock moving along the first path toward the reset catch under force of the biasing member, and the second tooth engaging a ramp adjacent the reset catch to reset and rotate back.

FIG. 5B is a close-up bottom view of FIG. 5A, depicting the interface between a pivot lock and a latch plate.

FIG. 6A is a bottom view of the fifth wheel with the second tooth engaging the reset catch moving along the first path about to clear the reset catch under force if the first biasing member.

FIG. 6B is a close-up bottom view of FIG. 6A, depicting the interface between a pivot lock and a latch plate.

FIG. 7A is a bottom view of the fifth wheel with the first tooth and pivot lock at the end of the first path with the pivot lock clearing the latch plate and a first stop of the pivot lock engaging a first limiter of the lever to cease rotation of the pivot lock about the pivot lock axis.

FIG. 7B is a close-up bottom view of FIG. 7A, depicting the interface between a pivot lock and a latch plate.

FIG. 8A is a bottom view of the fifth wheel with the lock bar contacting a stop block such that the lever ceases rotation and the lock bar ceases movement.

FIG. 8B is a zoom-in bottom view of FIG. 8A, depicting the interfaces of a lever with a pivot lock and a lock bar.

FIG. 9A is a bottom view of the fifth wheel with the first biasing member in an inactive mode so that the second biasing member urges the pivot lock along a second path opposite the first path, with the second tooth engaging the reset catch and the lock bar maintained in an open position, so that a lock jaw can move open and release the first kingpin.

FIG. 9B is a close-up bottom view of FIG. 9A, depicting the interface between a pivot lock and a latch plate.

FIG. 10A is a bottom view of the fifth wheel with the kingpin exiting the throat and engaging the lock jaw against the lever to disengage the second tooth from the reset catch of the latch plate.

FIG. 10B is a close-up bottom view of FIG. 10A, depicting the interface between a pivot lock and a latch plate.

FIG. 11A is a bottom view of the fifth wheel with the second biasing member urging the pivot lock along the second path past and clearing the reset catch, with the pivot lock rotating about the pivot lock axis relative to the lever, and the first kingpin fully exited from the throat.

FIG. 11B is a close-up bottom view of FIG. 11A, depicting the interface between a pivot lock and a latch plate.

FIG. 12A is a bottom view of the fifth wheel with a second kingpin entering the lock jaw past the lock bar, thereby moving the lever, where the pivot lock remains rotated with the second stop engaging the second limiter so the pivot lock is readied to clear the reset catch and move along the second path.

FIG. 12B is a close-up bottom view of FIG. 12A, depicting the interface between a pivot lock and a latch plate.

FIG. 13A is a bottom view of the fifth wheel with the second biasing member urging the pivot lock along the second path, opposite the first path, with the lock bar moving to the locked position and the second tooth sliding along a ramped surface adjacent the first tooth to clear the first catch.

FIG. 13B is a close-up bottom view of FIG. 13A, depicting the interface between a pivot lock and a latch plate.

FIG. 14A is a bottom view of the fifth wheel with the pivot lock continuing to travel along the second path toward a longitudinal axis of the fifth wheel, rotating about the pivot lock axis under force of the second biasing member.

FIG. 14B is a close-up bottom view of FIG. 14A, depicting the interface between a pivot lock and a latch plate.

FIG. 15A is a bottom view of the fifth wheel with the pivot lock continuing to travel along the second path toward a longitudinal axis of the fifth wheel, rotating about the pivot lock axis with the first tooth running up the ramp of the first catch.

FIG. 15B is a close-up bottom view of FIG. 15A, depicting the interface between a pivot lock and a latch plate.

FIG. 16A is a bottom view of the fifth wheel with the pivot lock ceasing movement under the force of the second biasing member when the lock bar contacts an adjustment bolt, with the first tooth adjacent the lock plate and in a recess adjacent the first catch so that the first tooth cannot move along the first path beyond the first catch to allow the kingpin to move from the closed position to the open position.

FIG. 16B is a close-up bottom view of FIG. 16A, depicting the interface between a pivot lock and a latch plate.

FIG. 17A is a bottom view of the fifth wheel with a kingpin causing the lock bar to squirt and rotate the lever and thereby disengage the pivot lock from the first catch.

FIG. 17B is a close-up bottom view of FIG. 17A, depicting the interface between a pivot lock and a latch plate.

FIG. 18A is a bottom view of the fifth wheel with a pivot lock biasing member damaged or disengaged from the pivot lock, with the second tooth engaging a safety catch of the latch plate so that the first tooth cannot clear the first catch and move along the first path toward the reset catch to thereby unlock the lock bar.

FIG. 18B is a close-up bottom view of FIG. 18A, depicting the interface between a pivot lock and a latch plate.

### DETAILED DESCRIPTION OF THE CURRENT EMBODIMENTS

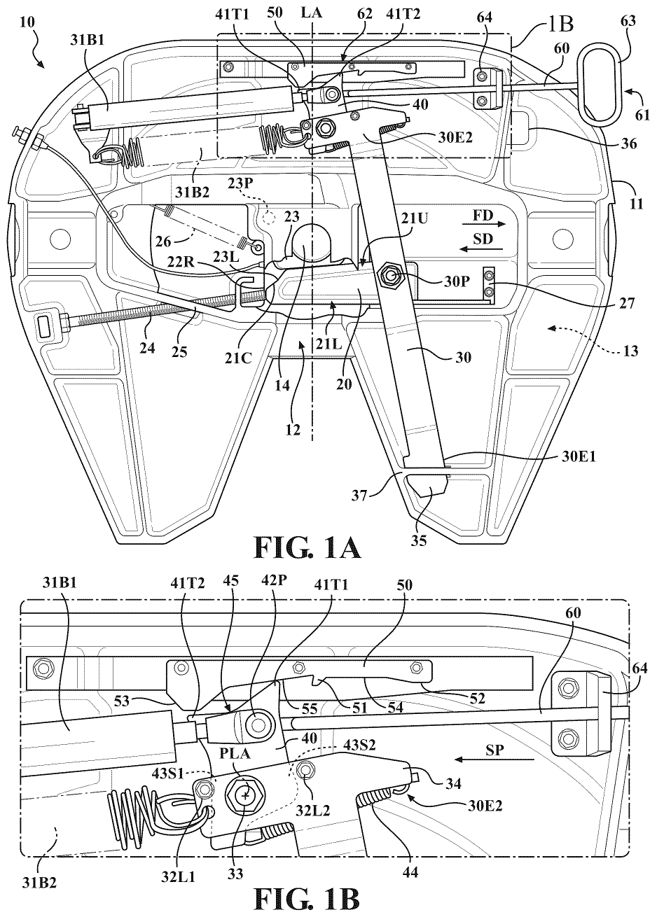

A current embodiment of the fifth wheel is shown in FIGS. 1-18 and generally designated 10. The fifth wheel 10 shown in FIGS. 1-18 is configured for use in a semi-trailer system, wherein the fifth wheel 10 is used to establish a secured connection between a semi-tractor and a semi-trailer. The fifth wheel 10 is mounted on a frame of the semi-tractor (e.g., a rear chassis above a drive axle of the semi-tractor), or another component of a truck, tractor, industrial equipment or vehicle. The fifth wheel 10 can include a top plate 11 defining a throat 12. The top plate 11 can be coupled to a base 13. The base 13 is mountable on the frame of the semi-tractor. The throat 12 is configured to receive a kingpin 14 of a trailer. The top plate 11 can be coupled to the base 13 such that the top plate 11 is pivotable such that the semi-trailer of the semi-trailer system may swivel about the kingpin 14, for example during turning of the semi and trailer or during general articulation between the semi and the trailer. In the semi-trailer system, the top plate 11 can be greased with a lubricant to reduce friction between the top plate 11 and the semi-trailer.

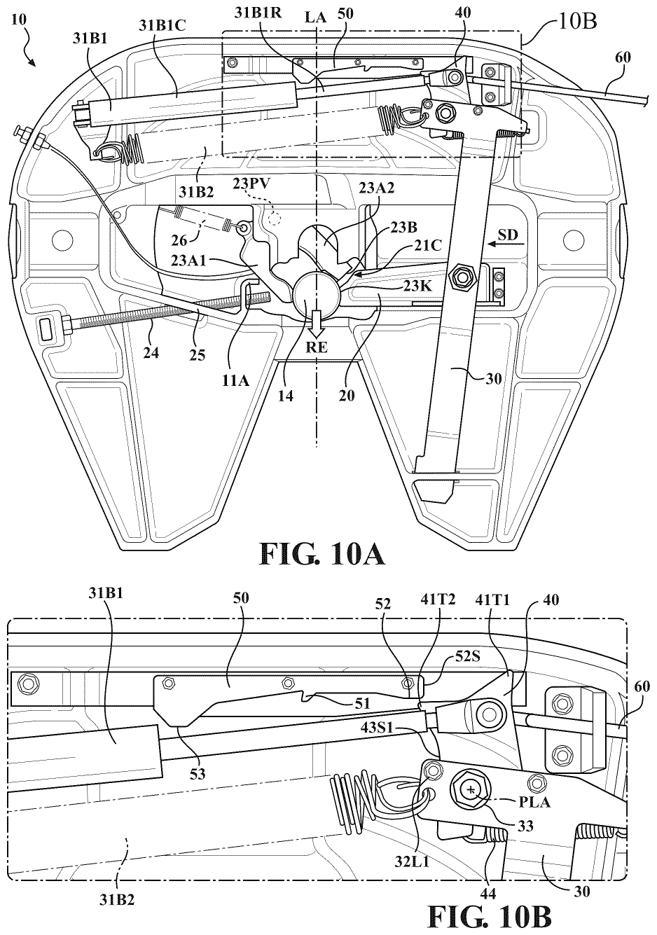

As shown in FIGS. 1-18, the fifth wheel 10 includes a lock bar 20. The lock bar 20 is slidable between a closed position shown in FIG. 1A and an open position shown in FIG. 10A. In the closed position the lock bar 20 blocks removal of the kingpin 14 from the throat 12. In the open position the removal of the kingpin 14 from the throat 12 is permitted. The lock bar 20 can define a forward surface 21U, a rear surface 21L, and a contact surface 21C including a rounded portion 22R and a beveled portion 22B. The forward surface 21U is configured to contact a lock jaw 23. The lock jaw 23 can include a first locking arm 23A1 and a second locking arm 23A2 as shown in FIG. 10A. The lock jaw 23 with the lock bar 20 are configured to retainably engage and hold the kingpin 14. The kingpin 14 can be disposed between the first locking arm 23A1 and the second locking arm 23A2 in the locked mode shown in FIG. 1A. The lock bar can be in the closed position there to secure the jaw and the king pin in the throat.

The lock jaw 23 can be pivotable about a lock jaw pivot 23PV between the closed position and the open position. In the closed position, shown in FIG. 1A, the forward surface 21U of the lock bar 20 can contact the first locking arm 23A1 of the lock jaw 23 such that the lock bar 20 and lock jaw 23 block, impair or prevent removal of the kingpin 14 from the throat 12. In the closed position, shown in FIG. 1A, the rounded portion 22R of the contact surface 21C can contact an adjustment bar 24 extending from the top plate 11 through an interior wall 25. The adjustment bar 24 can be screwed in or out relative to the portion 22R to adjust the position of the lock bar in the closed position for different parameters. In a knock-off position (e.g., the open position), shown in FIG. 10A, the first locking arm 23A1 contacts a casting rib 11A such that the removal of the kingpin 14 between the first locking arm 23A1 and the rounded portion 22R of the contact surface 21C from the throat 12 is permitted in direction RE. The lock jaw 23 is maintained in the open position from the closed position by a lock jaw biasing member 26. The lock jaw biasing member 26, which can be any type of spring or solenoid, such as a coil spring, leaf spring, etc. can be joined with the lock jaw tether 23P and extends between the lock jaw 23 and the interior wall 25. The kingpin 14 is removable from the throat 12 to decouple the trailer from the fifth wheel 10 when the lock bar 20 is in the open position.

The lock bar 20 is rotatably joined with a lever 30 at a locking bar pivot 30P. The lever 30 can include a first end 30E1 and a second end 30E2. The lock bar 20 can be rotatably joined with the lever 30 between the first end 30E1 and the second end 30E2 at the locking bar pivot 30P. The fifth wheel 10 can include a first biasing member 31B1 configured to urge the lever 30 in a first direction FD. The fifth wheel 10 can include a second biasing member 31B2 configured to urge the lever 30 in a second direction SD, opposite the first direction FD. The first biasing member 31B1 and the second biasing member 31B2 can be joined with the lever 30 at the second end 30E2. The first biasing member 31B1 can be aligned somewhat with the second biasing member 31B2 such that the biasing members exert opposing forces on the lever urging it in opposite directions in different phases of use of the lever.

The first biasing member and second biasing member can come in different configurations. Optionally, the first biasing member 31B1 can be an air cylinder which can be pressurized and depressurized via an onboard air system. When pressurized, the first biasing member can be put in an active mode in which it can move parts of the system. For example, when pressurized, the first biasing member can extend the ram 31B1R, which can in turn urge or push on the pivot lock 40 in direction FD, generally away from the cylinder 31B1C of the biasing member 31B1. When depressurized, the first biasing member can enter an inactive mode, in which it may not exert force on or urge the lever or other components in a particular direction, along any particular path as described herein. The first biasing member can come in other forms, such as a coil spring a, a large solenoid, a hydraulic ram, or other constructions.

Optionally, the second biasing member 31B2 can be a coil spring, or a double coil spring that can be stretched and can store return energy to move the lever when the first biasing member 31B1 is deactivated or placed in an inactive mode. The second biasing member generally can urge or pull on the lever 30 at its second end 30E2 to move the lever in the second direction SD as described further below. The second biasing member can come in other forms, such as an air cylinder, a large solenoid, a hydraulic ram, or other constructions.

The lever 30 optionally can include a first limiter 32L1 and a second limiter 32L2 joined with it somewhere so that those components can interface with the pivot lock to limit its rotation and/or movement during different phases of opening and closing the lock bar 20. The first limiter 32L1 and the second limiter 32L2 as shown can be disposed on the second end 30E2 of the lever 30. The lever 30 can include a lever hook 34 and a lever stop 35. The lever hook 34 is disposed on the second end 30E2 of the lever 30, while the lever stop 35 is disposed on the first end 30E1 of the lever 30.

As shown in FIGS. 1A-10B, the fifth wheel 10 can include a pivot lock 40. The pivot lock 40 can be rotatably joined with the second end 30E2 of the lever 30 at a pivot lock pivot 33. The pivot lock can rotate about the pivot lock axis PLA counterclockwise and clockwise. The pivot lock 40 can include optionally can include one or more teeth as defined below designed to interface with corresponding catches of the latch plate 50. For example, the pivot lock 40 can include a pivot lock first tooth 41T1 and a pivot lock second tooth 41T2 distal from the pivot lock pivot 33 and optionally from one another. The first tooth and second tooth can be separated by a concave recess disposed therebetween, with corresponding ramps leading from a low spot in the recess to each of the respective first and second teeth as described below.

As mentioned above, the pivot lock 40 can be joined with and moved via the first biasing member 31B1 and/or a force exerted on the actuator bar 60. That member can be rotatably and/or pivotally joined with the pivot lock 40 at an actuator pivot 42P such that the pivot lock 40 is moveable, rotatable and/or pivotable about a pivot lock axis PLA as described below. The pivot lock 40 further optionally can include a first stop 43S1 and a second stop 43S2. The first stop 43S1 can be aligned with the first limiter 32L1 of the lever 30 and the second stop 43S2 can be aligned with the second limiter 32L2 of the lever 30. When the first stop and first limiter engage or contact one another during different movements, the pivot lock can cease rotation or other movement. Likewise, when the second stop and the second limiter engage or contact one another, during other movements, the pivot lock can cease rotation or other movement.

Optionally, as shown in FIG. 1B, the pivot lock can be urged and or movement controlled via a pivot lock biasing member 44 which can be joined between the pivot lock 40 and the lever 30. The pivot lock biasing member can be in the form of a coil spring but can be any other type of biasing element described herein. The pivot lock biasing member can generally urge the pivot lock to rotate about the pivot lock axis such that the stop 43S1 engages the limiter 32L1. Optionally, as shown in the figures, the stops of the pivot lock can be in the form of edges of the pivot lock, while the limiters associated with the lever can be in the form of fasteners, pins, projections or other elements. Of course, the construction of the stops and limiters can be reversed and mixed and matched, or come in other forms to limit rotation of the pivot lock in other applications.

As mentioned above, the pivot lock 40 can include a concave recess between different teeth. For example, the pivot lock can define a concave edge 45 between the pivot lock first tooth 41T1 and the pivot lock second tooth 41T2. As used herein, the term “tooth” or “teeth” is understood to mean any protruding structure, ridge, or projection designed to engage, grip, interact with, or apply force to another surface or component. The term includes, but is not limited to, mechanical, structural, or functional protrusions that serve purposes such as locking, guiding, cutting, gripping, or engaging with another element.

With reference to FIGS. 1A-10A, the fifth wheel 10 can include a latch plate 50 disposed in proximity to the pivot lock 40. The latch plate 50 can include a first catch 51 and a reset catch 52 distal from the first catch 51. The latch plate 50 optionally can include a safety catch 53 (e.g., safety block and/or leaf spring). The latch plate 50 can define a ramp 54 disposed between the first catch 51 and the reset catch 52. The latch plate 50 can define a recess 55 disposed between the safety catch 53 and the first catch 51. As used herein, the term “catch” is understood to mean a structural feature designed to engage, retain, restrict, or interface with one or more teeth. The catch may function as a stop, locking mechanism, guide, or engagement point to control movement, positioning, or interaction between components. The term “catch” may include, but is not limited to, recesses, notches, protrusions, latches, or any form of mechanical engagement structure that operates in conjunction with teeth.

The pivot lock 40 and/or the latch plate 50 can be flat or substantially flat. The term “substantially flat” is understood to describe a surface or structure that is primarily planar but may include minor deviations, curvatures, or irregularities that do not significantly affect its intended function. The term allows for slight bends, contours, or non-uniformities. However, the pivot lock 40 and/or the latch plate 50 are not limited to flat or planar configurations, nor to constructions that are plate-like or flat. For example, the pivot lock 40 and/or the latch plate 50 can be curved, contoured, multi-surfaced, or irregularly shaped forms, provided the pivot lock 40 includes one or more teeth 41T2, 41T2 configured to engage with one or more the catches 51, 52, 53 and various ramps, for example, ramp 54 of the latch plate 50. In some cases, the latch plate can be fastened, secured, welded or otherwise secured to the top plate 11. The latch plate optionally can be removeable and replaceable relative thereto so that the part can be replaced and/or services after wear and tear or damage thereto. Likewise, the pivot lock can be removable and replaceable relative to the lever and other components in the fifth wheel.

The pivot lock 40 can be moveable and reconfigurable in a variety of modes and can move on different paths depending on the operation of the fifth wheel. For example, the pivot lock can move, rotate and/or toggle from a locked mode to an unlocked mode and vice versa. As shown in FIGS. 1A, 1B, in the locked mode the pivot lock can be positioned so that the pivot lock first tooth 41T1 is aligned to engage the first catch 51. Specifically, the pivot lock 40 is operable in the locked mode such that the pivot lock first tooth 41T1 will engage or is engaged with the first catch 51, thereby preventing rotation of the lever 30 and thus securing the lock bar 20 in the closed position shown in FIG. 1A. Optionally, the safety catch 53 of the latch plate 50 is configured to engage the pivot lock second tooth 41T2 when the lock bar 20 is in the closed position so that the pivot lock 40 cannot transition from the locked mode to the unlocked mode. For example, the second tooth can engage the safety catch to prevent further rotation of the pivot lock 40 to prevent the first tooth 41T1 from clearing the first catch 51 thereby allowing or facilitating an unlocking condition of the system as described below when a spring fails.

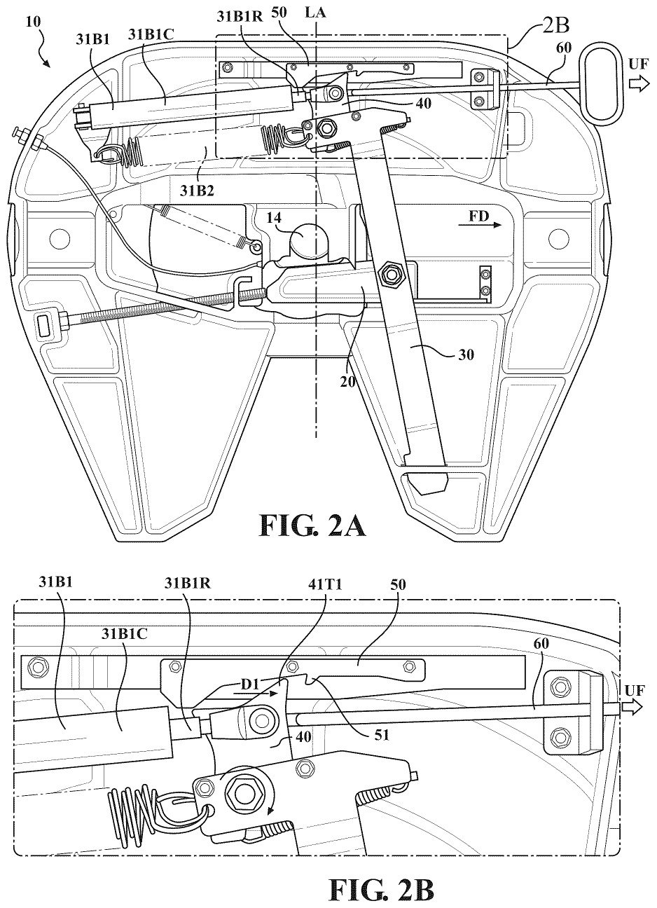

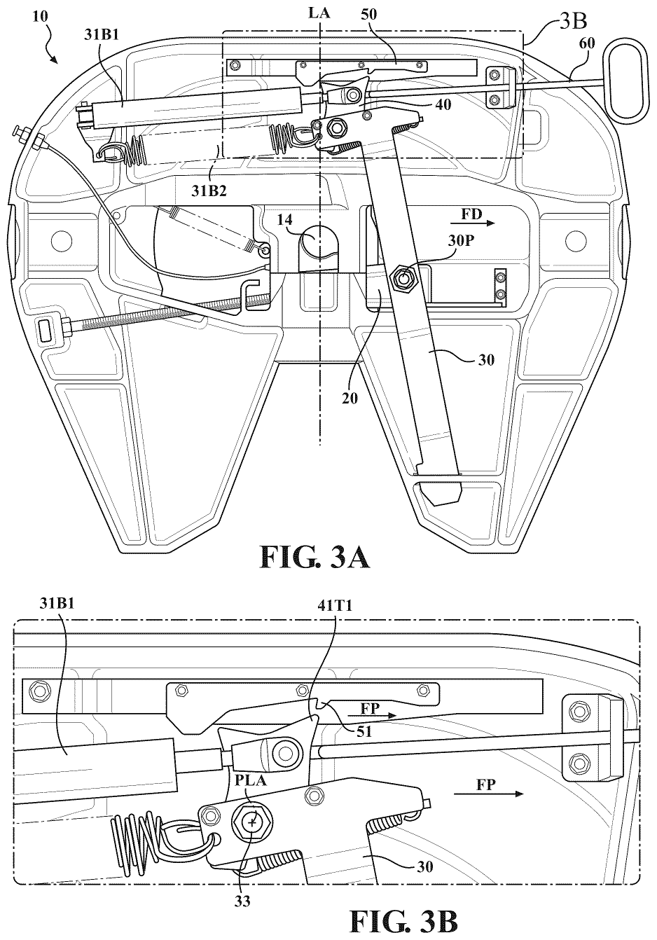

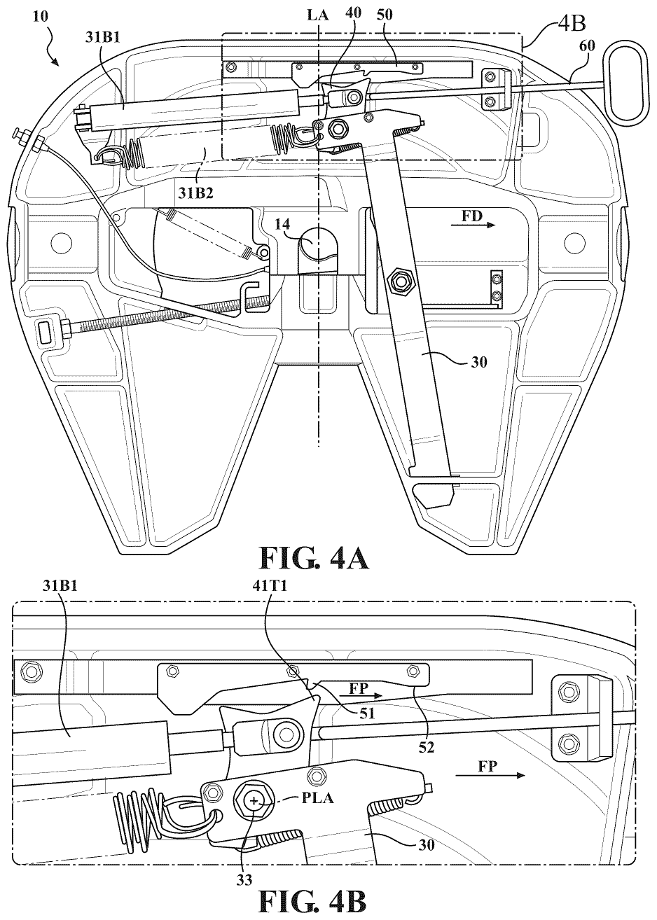

As shown in FIGS. 2A-7B, the first biasing member 31B1 of the lever 30 is configured to urge the pivot lock first tooth 41T1 adjacent the latch plate 50 along a first path FP past the first catch 51 toward and/or past the reset catch 52. The first biasing member 31B1 can be an air cylinder and can be put in an activation mode to extend. As shown in FIG. 2B, the actuator bar 60 can be actuated manually by a user via a user force UF, which pulled the pivot lock 40 in direction D1. The second biasing member 31B2 can exert a counterforce and the pivot lock can rotate to initially disengage the pivot lock 40 and the pivot lock first tooth 41T1 from the first catch 51 of the latch plate 50. The first biasing member 31B1 can rotate the pivot lock first tooth 41T1 clockwise, allowing for movement along the first path FP. As shown in FIGS. 3B and 4B, the first biasing member 31B1 continues to hold the pivot lock first tooth 41T1 in a clearance mode such that the pivot lock first tooth 41T1 is able to clear the first catch 51 as the pivot lock first tooth 41T1 moves along the first path FP toward the reset catch 52 under a force of the first biasing member 31B1. As the first biasing member 31B1 moves the pivot lock 40 along the first path FP the lever 30 is likewise rotated clockwise about the locking bar pivot 30P by the force acting on the pivot lock pivot 33 such that the lock bar 20 is moved from the closed position toward the open position.

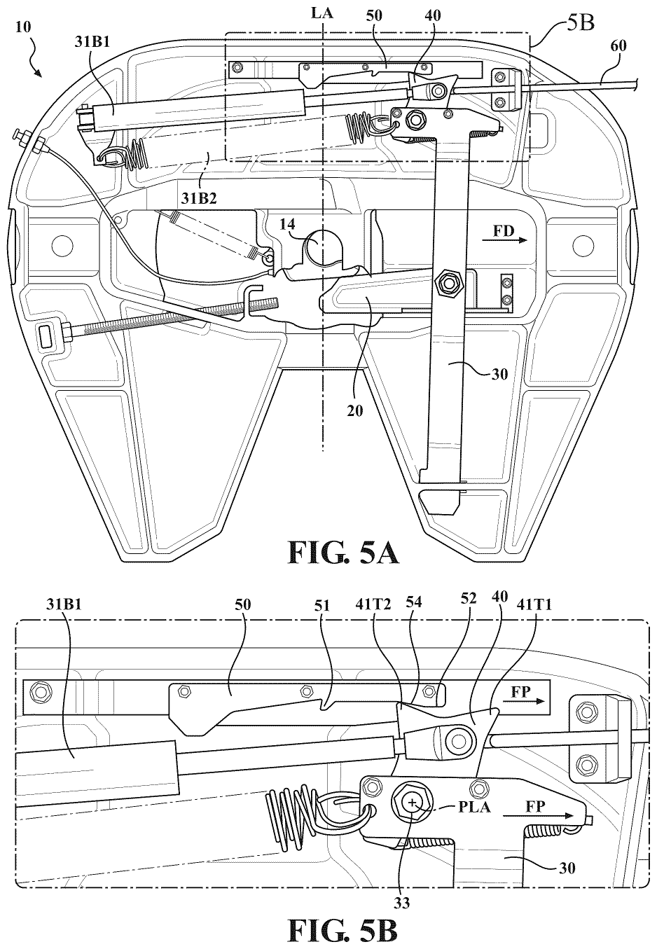

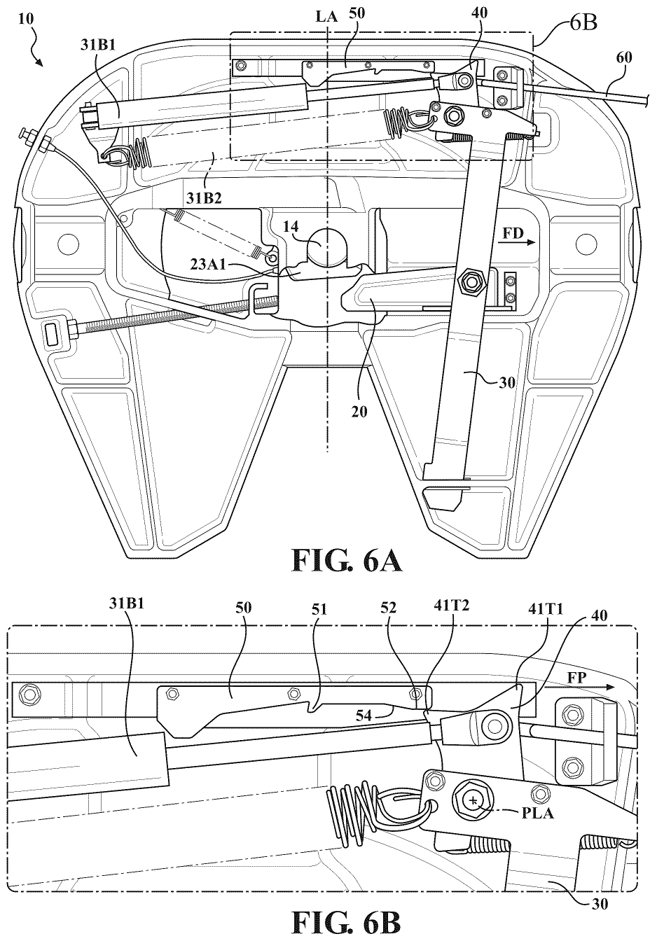

As shown in FIGS. 5A and 5B, the first biasing member 31B1 can continue to move the pivot lock first tooth 41T1 and the pivot lock 40 along the first path FP toward the reset catch 52 under the force of the first biasing member 31B1 and/or a force exerted on the actuator bar 60. The pivot lock 40 can pivot clockwise about the pivot lock pivot 33 such that the pivot lock second tooth 41T2 engages the ramp 54. With reference to FIG. 6B, the first biasing member 31B1 continues to move the pivot lock 40 along the first path FP such that pivot lock second tooth 41T2 moves along the ramp 54 until the pivot lock second tooth 41T2 engages the reset catch 52. The pivot lock first tooth 41T1 moves over the reset catch 52 of the latch plate 50 as the pivot lock 40 moves adjacent the latch plate 50. During the movement of the first tooth along the first path, the first tooth optionally moves along or adjacent the latch plate, away from the longitudinal axis LA of the fifth wheel 10. As the tooth moves along the path FP, it further optionally can rotate about the pivot lock axis PLA as described further below.

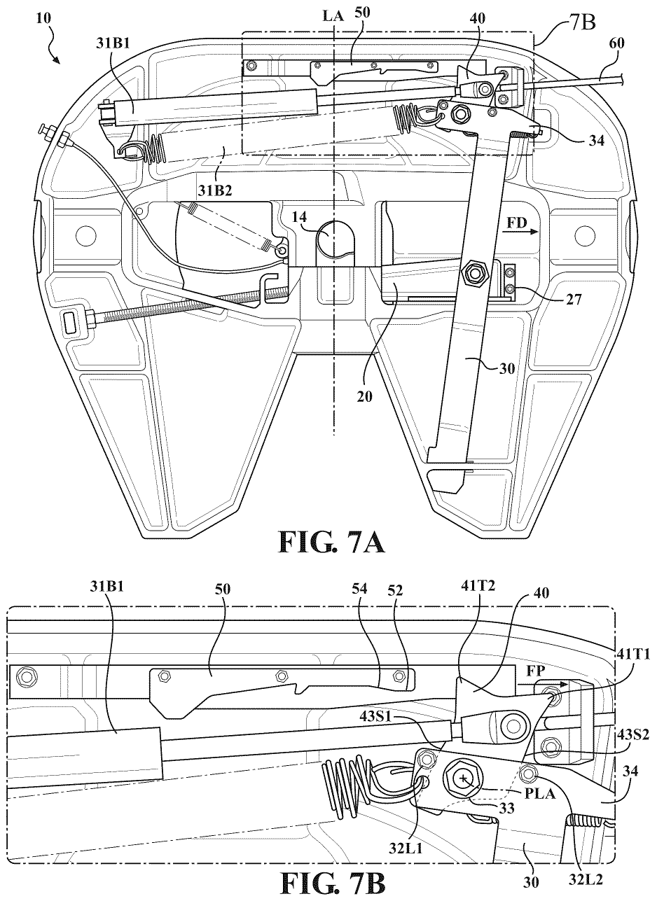

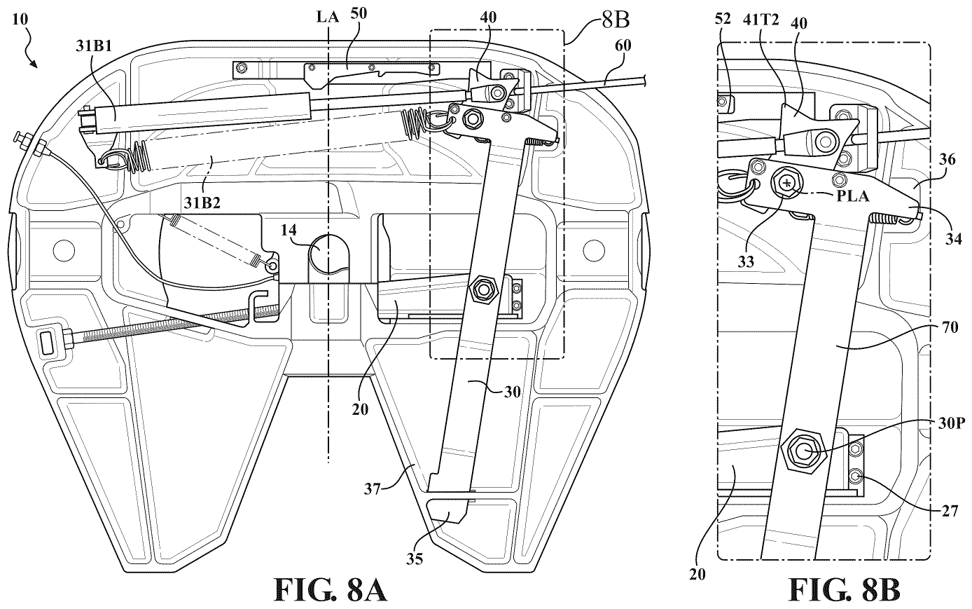

Referring further to FIGS. 6A and 6B, in continuing to convert the lock bar from the closed position to the open position to release the king pin, as the first biasing member 31B1 and/or a force exerted on the actuator bar 60 moves the pivot lock 40 farther along the first path FP, the pivot lock second tooth 41T2 clears the reset catch 52 of the latch plate 50. Having cleared this rotation-restricting reset catch, as shown in FIGS. 7A and 7B, the pivot lock 40 rotates clockwise. As a result of this rotation, the first tooth moves and rotates away from the longitudinal axis LA until the first stop 43S1 of the pivot lock 40 engages the first limiter 32L1 of the lever 30, ceasing the clockwise rotation of the pivot lock 40 about the pivot lock axis PLA of the pivot lock pivot 33. The pivot lock 40, as well as the tooth 41T1 however, can continue to move along the first path FP until the lock bar 20 contacts a stop block 27 and the lever stop 35 contacts a lever stop wall 37 defined by the fifth wheel 10 or top plate 11, thereby stopping the clockwise rotation of the lever 30. The pivot lock 40 at the end of the first path FP is shown in FIG. 8B, where the second tooth 41T2 and pivot lock 40 have well cleared the reset catch 52 of the latch plate 50.

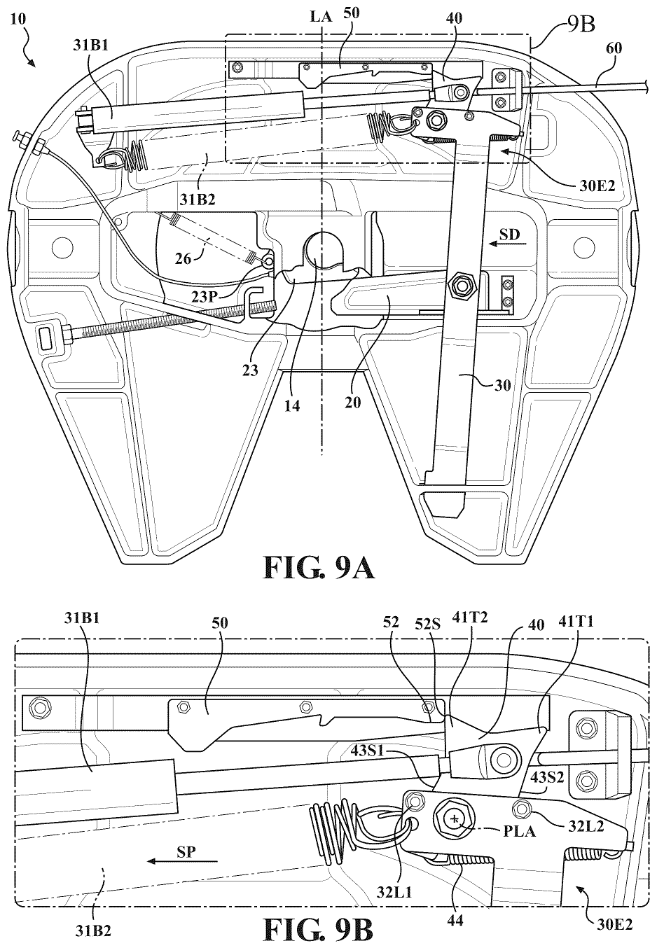

As depicted in FIGS. 9A and 9B, the lever 30 is rotated counterclockwise and the first biasing member 31B1 and/or a force exerted on the actuator bar 60 ceases urging the lever 30 along the first path FP, optionally when the first biasing member enters an inactive mode. In this inactive mode, the first biasing member may be operated such that it no longer exerts a force against the lever. This may be achieved if the first biasing member is an air or pneumatic cylinder, and it is no longer pressurized. In the inactive mode of the first biasing member, the second biasing member 31B2 can take over movement forces exerted on the lever, and can urge the lever 30 along a second path SP.

This second path SP optionally can be generally opposite the first path FP, and can be directed back toward the longitudinal axis LA of the fifth wheel. The second end 30E2 of the lever 30 can be pivotally joined with the second biasing member 31B2 configured to urge the pivot lock first tooth 41T1 along the second path SP. The second biasing member 31B2 continues urging the pivot lock second tooth 41T2 to engage the reset catch 52 on its stopping surface 52S to hold the lever 30 in a fixed position, without further rotation under force of the springs 31B2 and maintain the lock bar 40 in the open position as shown in FIGS. 9A and 10A. In the knock off position of the lock bar shown there, the lock jaw biasing member 26 urges rotation of the lock jaw 23 about the lock jaw pivot 23PV such that the arms 23A1 and 23A2 are open to the throat, so that the kingpin 14 may be released from the throat 12 of the fifth wheel 10.

With reference to FIG. 9B, the pivot lock 40 is operable in the unlocked mode in which the pivot lock second tooth 41T2 engages the reset catch 52 and the surface 52S to hold the lever 30 in a position and maintain the lock bar 20 in the open position. The first stop 43S1 engages the first limiter 32L1 of the lever 30 when the pivot lock second tooth 41T2 engages the reset catch 52.

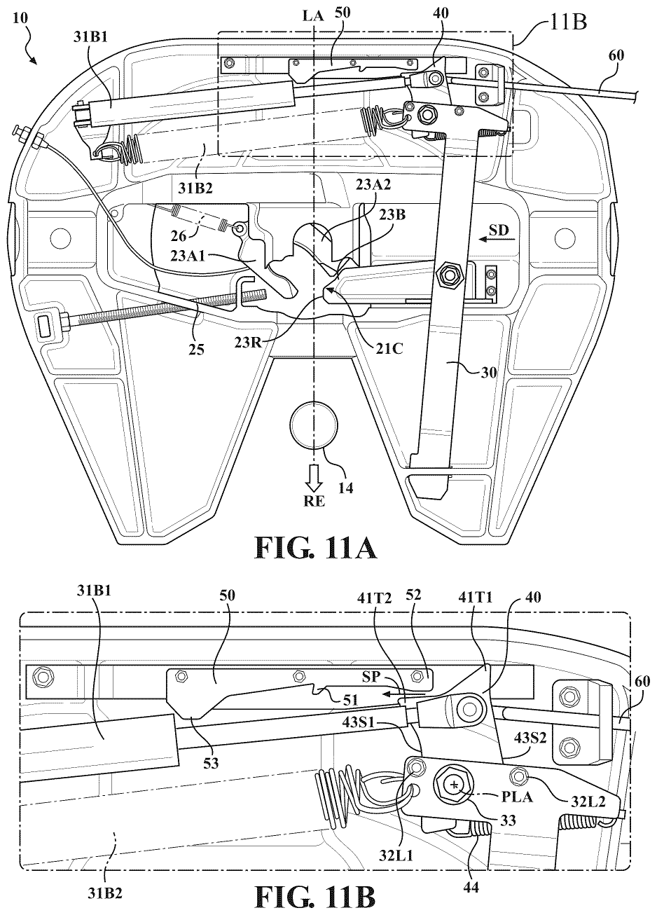

With reference to FIGS. 10A and 11A, the lock jaw 23 pivots about the lock jaw pivot 23P, transitioning into the open position where the first locking arm 23A1 contacts the casting rib 11A such that the removal of the kingpin 14 between the first locking arm 23A1 and the rounded portion 22R of the contact surface 21C from the throat 12 is permitted. The kingpin 14 contacts the rounded portion 22R of the contact surface 21C of the lock bar 20, engaging the lock bar 20 against the lever 30 such that the pivot lock second tooth 41T2 is disengaged from the reset catch 52 of the latch plate 50 as shown in FIGS. 10B and 11B. The pivot lock biasing member 44 urges the first stop 43S1 to engage the first limiter 32L1 of the lever 30 to urge the pivot lock 40 into a reset catch clearance mode (e.g., a “ready to couple” condition). In the reset catch clearance mode the pivot lock second tooth 41T2 clears the reset catch 52, allowing the pivot lock second tooth 41T2 to travel toward the first catch 51 along the latch plate 50 along the second path SP with the first tooth.

As depicted in FIGS. 11A and 11B, the second biasing member 31B2 urges the pivot lock 40 along the second path SP such that the pivot lock second tooth 41T2 clears the reset catch 52, with the pivot lock 40 rotating counterclockwise about the pivot lock axis PLA relative to the lever 30. The kingpin 14 can continue in direct RE and can fully exited the throat 12 of the fifth wheel 10.

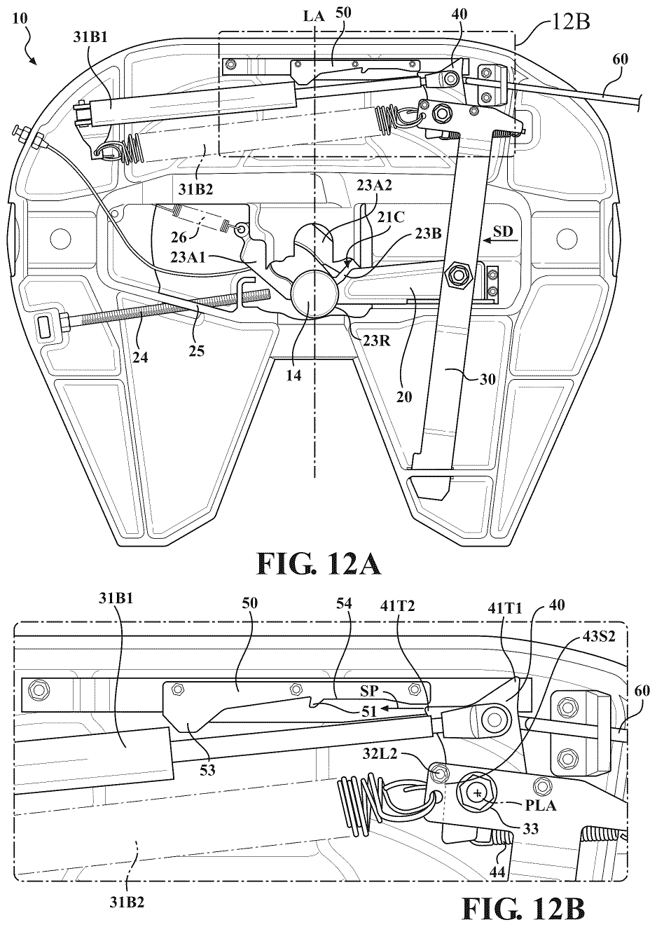

After removal of the kingpin from the fifth wheel, the lock bar 20 is held in the open mode by the lock jaw arm 23A2, that kingpin or another kingpin of another trailer can be hooked to the fifth wheel to join a trailer to the vehicle to which the fifth wheel is attached. For example, as shown in FIGS. 12A and 12B, the kingpin 14 (which may be the same or different kingpin as the kingpin that was removed) can enter the lock jaw 23, pass the lock bar 20 and contact the rounded portion 22R of the contact surface 21C of the lock bar 20. This can engage the lock bar 20 against the lever 30. The entry of the kingpin 14 can move the lever 30 such that is rotates clockwise about the locking bar pivot 30P. The pivot lock 40 can rotate such that the second stop 43S2 engages the second limiter 32L2. In this condition, the pivot lock 40 can be configured to move along the second path SP and clear the reset catch.

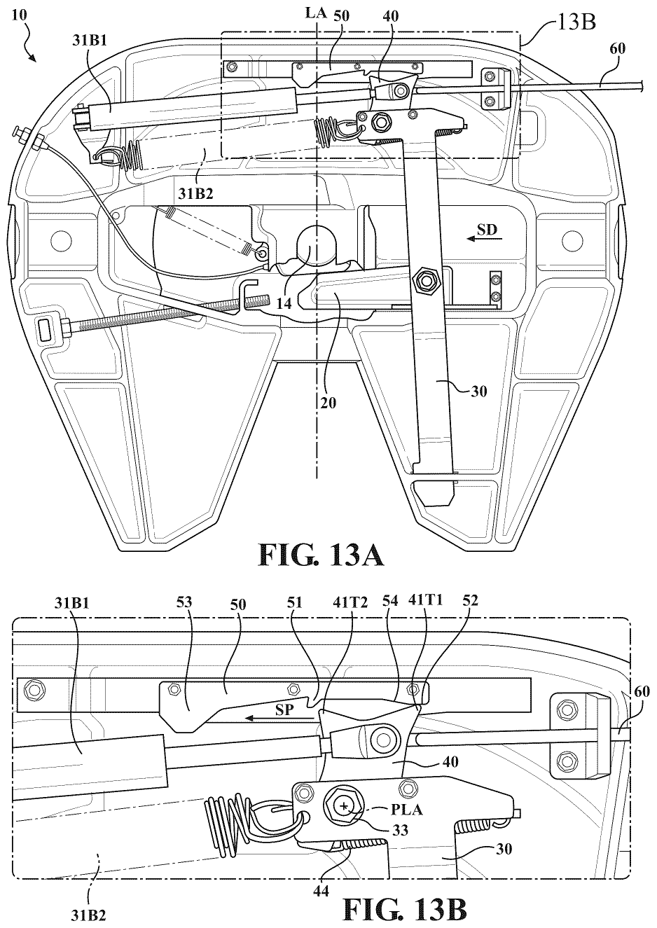

With reference to FIGS. 13A and 13B, the second biasing member 31B2 can urge the pivot lock 40 along the second path SP. The lock bar 20 can move from the unlocked position toward the locked position as the pivot lock 40 moves along the second path SP. The pivot lock second tooth 41T2 can engage and slide along the ramp 54 to clear the first catch 51. The pivot lock biasing member 44 can urge the pivot lock 40 to move along the latch plate 50 as the second biasing member 31B2 moves the lever 30 to transition the lock bar 20 from the open position to the closed position.

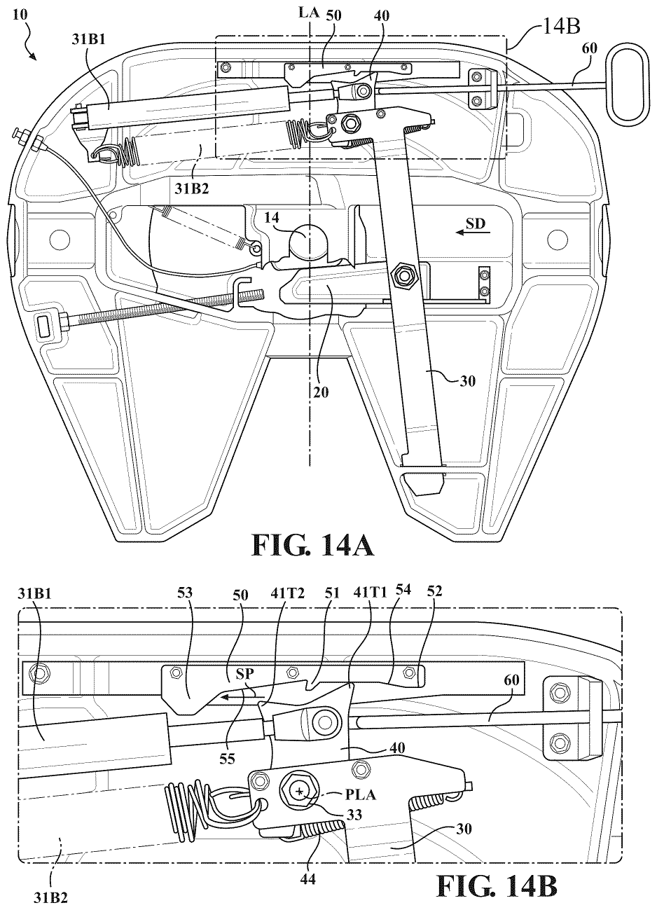

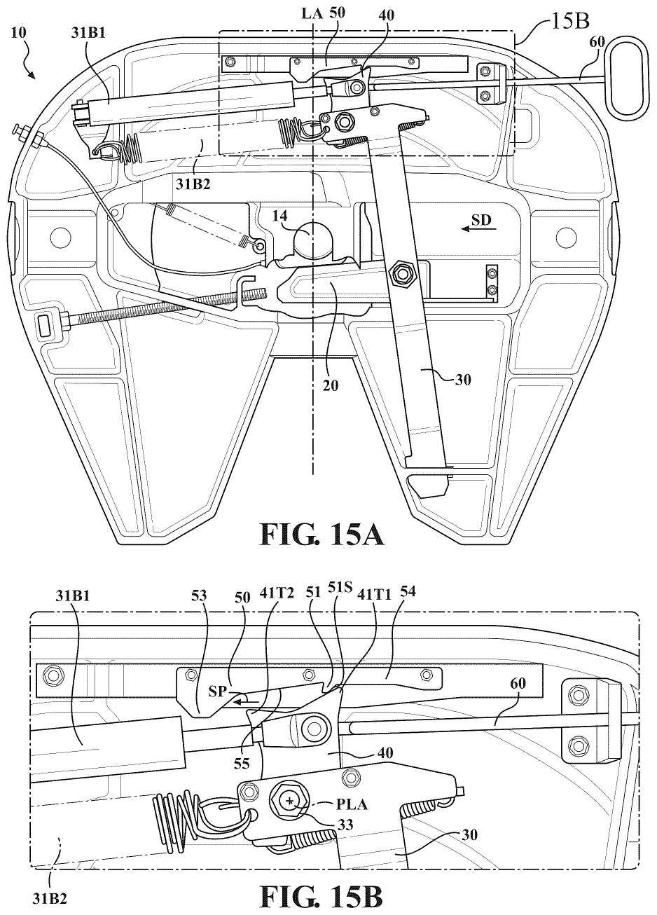

FIGS. 14A and 14B depict the pivot lock 40 continuing to travel along the second path SP toward a longitudinal axis LA of the fifth wheel 10 with the pivot lock second tooth 41T2 clearing the first catch 51. The pivot lock 40 rotates counterclockwise about the pivot lock axis PLA under a force exerted by the second biasing member 31B2. The pivot lock first tooth 41T1 engages and slides along the ramp 54. In FIG. 15B, the pivot lock 40 continues to travel along the second path SP toward a longitudinal axis LA of the fifth wheel 10. The pivot lock 40 rotates counterclockwise about the pivot lock axis PLA such that the pivot lock first tooth 41T1 engages and slides up the ramp 51S on the rear surface of the catch 51 such that the first tooth clears the first catch 51.

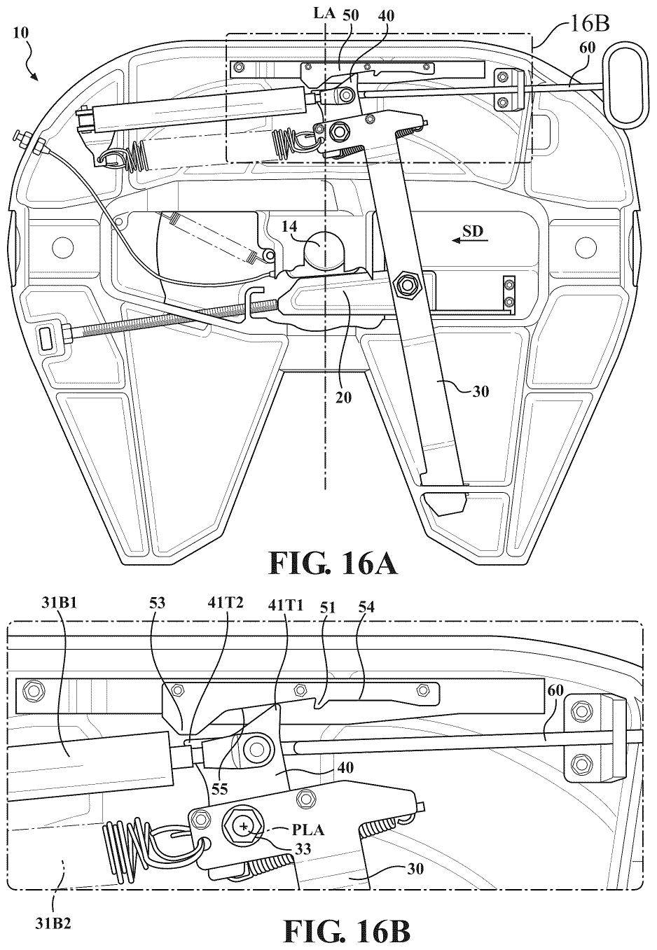

With reference to FIGS. 16A-16B, the pivot lock 40 ceases its movement along the second path SP under the force of the second biasing member 31B2 when the rounded portion 22R of the contact surface 21C of the lock bar 20 contacts the adjustment bar 24. The pivot lock first tooth 41T1 is disposed adjacent the latch plate 50 and is located in the recess 55, between the catch 51 and the longitudinal axis LA. The pivot lock first tooth 41T1 is prevented from moving along the first path FP beyond the first catch 51, away from the longitudinal axis. This disposition prevents the movement of the slide bar and/or lock jaw from the closed position to the open position, thereby retaining the kingpin 14.

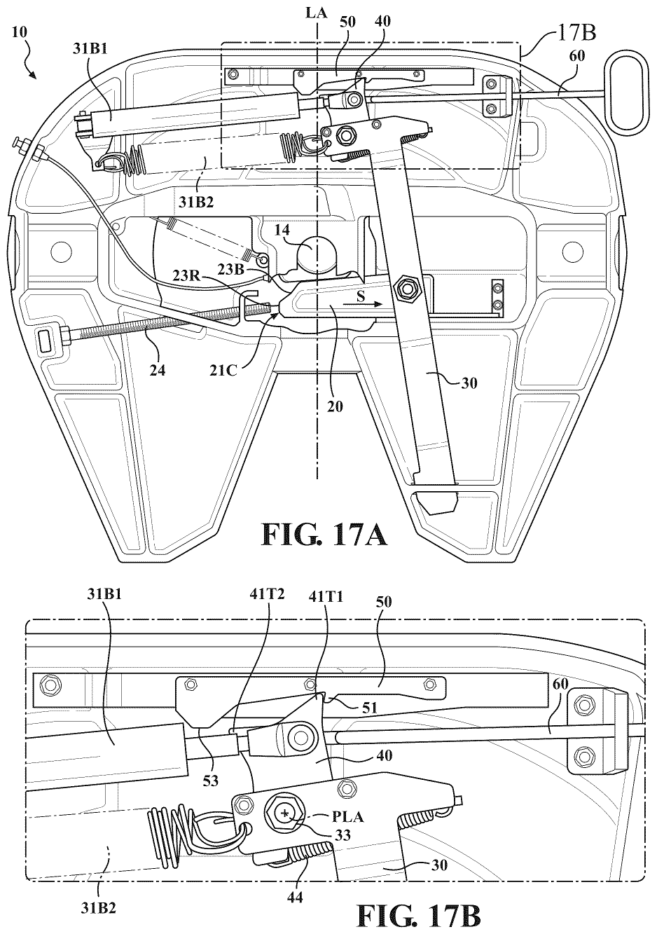

The fifth wheel 10 herein also can provide extra safety features to prevent the pivot lock from inadvertently unlocking during a condition of squirting, for example, when the lock bar under tremendous force by the kingpin such that it is urged to move slightly out of the throat, thereby rotating the lever and the associated pivot lock. With reference to FIGS. 17A and 17B, the lock bar 20 squirts in direction S such that the rounded portion 22R of the contact surface 21C of the lock bar 20 no longer contacts the adjustment bar 24 and rotates the lever 30 clockwise about the pivot lock axis PLA. The pivot lock first tooth 41T1, however, will automatically engage the first catch 51 due to the spring 44, such that the pivot lock 40 cannot move farther along the first path FP beyond the first catch. Accordingly, the lock bar cannot move from the closed position to the open position and allow the kingpin 14 to be inadvertently released.

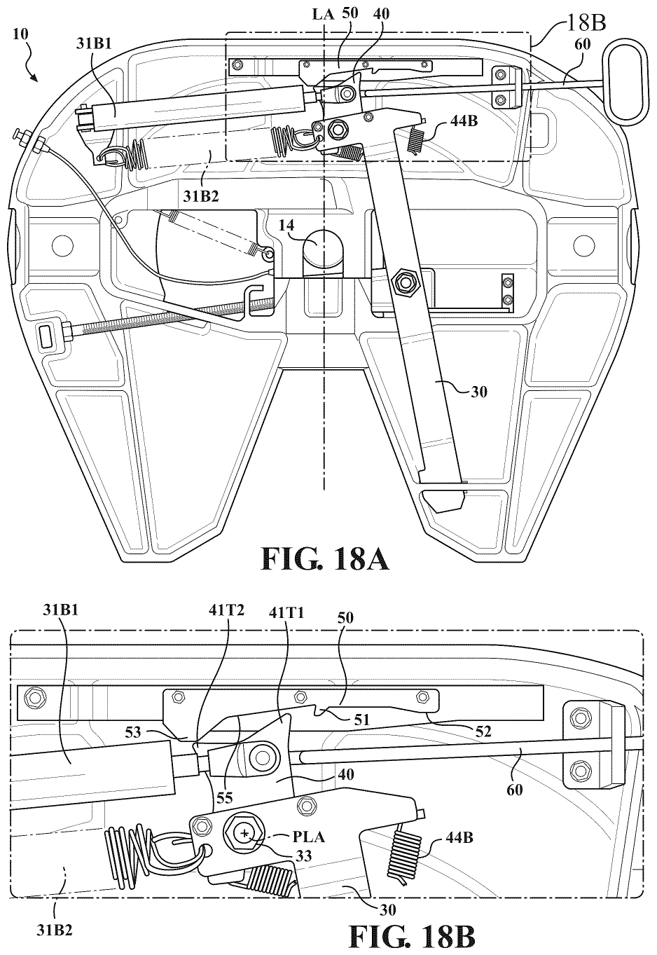

The fifth wheel 10 herein can provide extra safety features to prevent the pivot lock from inadvertently unlocking if a pivot lock biasing member no longer functions to engage the pivot lock first tooth with the first catch, for example, when the pivot lock biasing member is broken into parts (such as a broken coil spring), damaged or disengaged from the pivot lock. For example, FIGS. 18A and 18B show a pivot lock biasing member 44B that has broken into parts, in which case it no longer exerts a force on the pivot lock to engage the catch 51. Even in this broken condition of the spring, however, the pivot lock second tooth 41T2 will engage the safety block 53 of the latch plate 50. This engagement of the pivot lock second tooth 41T2 with the safety block 53 prevents the pivot lock first tooth 41T1 from clearing the first catch 51 and moving along the first path FP toward the reset catch 52. The engagement of the pivot lock second tooth 41T2 and the safety block 53 therefore prevents the lock bar 20 from moving from the open position to the closed position. It will be appreciated that the configuration of and engagement between the pivot lock 40 and the latch plate 50 is effective in securely retaining the kingpin 14 within the throat 12 of the fifth wheel 10, even in circumstances where the lock bar 20 squirts or the pivot lock biasing member 44 fails.

As mentioned above, the fifth wheel 10 can include an actuator bar 60 joined with the pivot lock 40 and configured to move the pivot lock 40. As shown in FIG. 1A, the actuator bar 60 can be rotatably joined with the pivot lock 40 at the actuator pivot 42P. The actuator bar 60 can include a first end 61 and a second end 62. The first end 61 can include a handle 63 disposed outside of the fifth wheel 10 and graspable by a user to move the pivot lock 40. The second end 62 can be rotatably joined with the pivot lock 40 at the actuator pivot 42P. The actuator bar 60 terminates adjacent the actuator pivot 42P. The actuator bar 60 and the first biasing member 31B1 can both be rotatably joined with the pivot lock 40 via an actuator pivot 42P extending through the pivot lock 40. The actuator bar 60 can be at least partially disposed within an actuator bar retainer bracket and guide 64 disposed within the fifth wheel 10.

Although the different elements and assemblies of the embodiments are described herein as having certain functional characteristics, each element and/or its relation to other elements can be depicted or oriented in a variety of different aesthetic configurations, which support the ornamental and aesthetic aspects of the same. Simply because an apparatus, element or assembly of one or more of elements is described herein as having a function does not mean its orientation, layout or configuration is not purely aesthetic and ornamental in nature.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

In addition, when a component, part or layer is referred to as being “joined with,” “on,” “engaged with,” “adhered to,” “secured to,” or “coupled to” another component, part or layer, it may be directly joined with, on, engaged with, adhered to, secured to, or coupled to the other component, part or layer, or any number of intervening components, parts or layers may be present. In contrast, when an element is referred to as being “directly joined with,” “directly on,” “directly engaged with,” “directly adhered to,” “directly secured to,” or “directly coupled to” another element or layer, there may be no intervening elements or layers present. Other words used to describe the relationship between components, layers and parts should be interpreted in a like manner, such as “adjacent” versus “directly adjacent” and similar words. As used herein, the term “and/or” includes any and all combinations of one or more of the associated listed items.

The above description is that of current embodiments of the invention. Various alterations and changes can be made without departing from the broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, any combination of X, Y and Z, for example, X, Y, Z; X, Y; X, Z; Y, Z, and/or any other possible combination together or alone of those elements, noting that the same is open ended and can include other elements.

Reference throughout this specification to “a current embodiment” or “an embodiment” or “alternative embodiment” means that a particular feature, structure, or characteristic described in connection with the embodiment is included in at least one embodiment herein. Accordingly, the appearance of the phrases “in one embodiment” or “in an embodiment” or “in an alternative embodiment” in various places throughout this specification are not necessarily all referring to the same embodiment. Additionally, the features, structures, or characteristics of one embodiment are contemplated for proper and full combination in any suitable manner in one or more other embodiments, which is fully contemplated herein. Further, features, structures, or characteristics of one embodiment or multiple embodiments are readily and completely mixed and matched with any features, structures, or characteristics of any other embodiment or multiple embodiments in varying combinations and permutations.

What is claimed is:

1. A fifth wheel comprising:
a top plate defining a throat configured to receive a kingpin of a trailer;
a lock bar slidable between a closed position where the lock bar blocks removal of the kingpin from the throat and an open position permitting removal of the kingpin from the throat;
a lever including a first end and a second end, the lock bar rotatably joined with the lever between the first end and the second end at a lock bar pivot;
a pivot lock rotatably joined with the second end of the lever at a pivot lock pivot, the pivot lock including a pivot lock first tooth and a pivot lock second tooth distal from the pivot lock pivot;
an actuator bar joined with the pivot lock and configured to move the pivot lock; and
a latch plate disposed in proximity to the pivot lock, the latch plate including a first catch and a reset catch distal from the first catch,
wherein the pivot lock is operable in a locked mode in which the pivot lock first tooth engages the first catch thereby preventing rotation of the lever and thus securing the lock bar in the closed position,
wherein the pivot lock is operable in an unlocked mode in which the pivot lock second tooth engages the reset catch to hold the lever in a position and thus maintain the lock bar in the open position,
whereby the kingpin is removable from the throat to decouple the trailer from the fifth wheel when the lock bar is in the open position.

2. The fifth wheel of claim 1, comprising:
a first biasing member configured to urge the lever in a first direction;
a second biasing member configured to urge the lever in a second direction, opposite the first direction.

3. The fifth wheel of claim 2,
wherein the first biasing member is rotatably joined with the pivot lock at an actuator pivot,
wherein the actuator bar is rotatably joined with the pivot lock at the actuator pivot,
wherein the second biasing member is joined with the lever at the second end.

4. The fifth wheel of claim 3,
wherein the first biasing member is an air cylinder,
wherein the air cylinder ceases urging the lever in the first direction in an inactive mode, such that the second biasing member urges the lever in the second direction, thereby urging the pivot lock second tooth to engage the reset catch to hold the lever in a position and thus maintain the lock bar in the open position.

5. The fifth wheel of claim 4,
wherein the pivot lock includes a first stop and the lever includes a first limiter,
wherein the first stop engages the first limiter when the pivot lock second tooth engages the reset catch such that the pivot lock is impaired from rotating about the pivot lock axis.

6. The fifth wheel of claim 1, comprising:
a biasing member configured to urge the pivot lock to move along the latch plate as the biasing member moves the lever to transition the lock bar from the open position to the closed position,
wherein the pivot lock first tooth moves over the reset catch and the first catch of the latch plate as the pivot lock moves adjacent the latch plate.

7. The fifth wheel of claim 1,
wherein the pivot lock includes a first stop and a second stop,
wherein the lever includes a first limiter aligned with the first stop and a second limiter aligned with the second stop,
wherein a pivot lock biasing member is joined between the pivot lock and the lever,
wherein the pivot lock biasing member urges the second stop to engage the second limiter to urge the pivot lock into a reset catch clearance mode in which the pivot lock second tooth clears the reset catch thereby allowing the pivot lock second tooth to travel toward the first catch on the latch plate.

8. The fifth wheel of claim 7,
wherein the latch plate includes a safety catch,
wherein the safety catch is configured to engage the pivot lock second tooth when the lock bar is in the closed position so that the pivot lock cannot transition from the locked mode to the unlocked mode.

9. The fifth wheel of claim 1,
wherein the pivot lock toggles from the locked mode in which the pivot lock first tooth is aligned to engage the first catch to the unlocked mode in which the pivot lock first tooth is misaligned with and clears the first catch such that the pivot lock first tooth and the pivot lock second tooth each travel past the first catch and the reset catch.

10. The fifth wheel of claim 1,
wherein the pivot lock is pivotally joined with a first biasing member configured to urge the first tooth adjacent the latch plate along a first path past the first catch toward the reset catch,
wherein the second end of the lever is pivotally joined with a second biasing member configured to urge the first tooth along a second path, opposite the first path.

11. A fifth wheel comprising:
a top plate defining a throat configured to receive a kingpin of a trailer;
a lock bar slidable between a closed position where the lock bar blocks removal of the kingpin from the throat and an open position permitting removal of the kingpin from the throat;
a lever rotatably joined with the lock bar;
a pivot lock rotatably joined with the lever at a pivot lock pivot, the pivot lock including a pivot lock first tooth and a pivot lock second tooth distal from the pivot lock pivot; and
a latch plate disposed in proximity to the pivot lock, the latch plate including a first catch and a reset catch distal from the first catch,
wherein the pivot lock is operable in a locked mode in which the pivot lock first tooth engages the first catch thereby preventing rotation of the lever and thus securing the lock bar in the closed position,
wherein the pivot lock is operable in an unlocked mode in which the pivot lock second tooth engages the reset catch to hold the lever in a position and thus maintain the lock bar in the open position,
whereby the kingpin is removable from the throat to decouple the trailer from the fifth wheel when the lock bar is in the open position.

12. The fifth wheel of claim 11,
wherein the latch plate includes a safety catch distal from the first catch, with the first catch disposed between the safety catch and the reset catch,
wherein the pivot lock second tooth is configured to engage the safety catch to prevent the lock bar from transitioning from the open position.

13. The fifth wheel of claim 11, comprising:
an actuator bar including a handle graspable by a user to move the pivot lock,
a first biasing member configured to urge the pivot lock first tooth along a first path past the first catch toward the reset catch.

14. The fifth wheel of claim 13,
wherein the actuator bar and the first biasing member are both rotatably joined with the pivot lock via an actuator pivot extending through the pivot lock.

15. The fifth wheel of claim 11, comprising:
an actuator bar including a first end having a handle graspable by a user to move the pivot lock and a second end that is rotatably joined with the pivot lock at an actuator pivot, the actuator bar terminating adjacent the actuator pivot.

16. The fifth wheel of claim 11,
wherein the pivot lock extends away from the lever toward the latch plate,
wherein the pivot lock first tooth is operable in a clearance mode in which the pivot lock first tooth clears the first catch as the first tooth travels along a first path toward the reset catch as the pivot lock transitions from the locked mode to the unlocked mode.

17. The fifth wheel of claim 16,
wherein the pivot lock includes a first stop and a second stop distal from the first stop,
wherein the lever includes a first limiter aligned with the first stop and a second limiter aligned with the second stop,
wherein a pivot lock biasing member is joined between the pivot lock and the lever,
wherein the pivot lock biasing member urges the second stop to engage the second limiter to urge the pivot lock into a reset catch clearance mode in which the pivot lock second tooth clears the reset catch thereby allowing the pivot lock second tooth to travel toward the first catch on the latch plate.

18. A fifth wheel comprising:
a top plate defining a throat configured to receive a kingpin of a trailer;
a lock bar slidable between a closed position where the lock bar blocks removal of the kingpin from the throat and an open position permitting removal of the kingpin from the throat;
a lever rotatably joined with the lock bar;
a pivot lock rotatably joined with the lever at a pivot lock pivot, the pivot lock including a pivot lock first tooth and a pivot lock second tooth distal from the pivot lock pivot; and
a latch plate disposed in proximity to the pivot lock, the latch plate including a first catch and a reset catch distal from the first catch, the pivot lock first tooth and pivot lock second tooth distal from the lever and protruding toward the latch plate;
wherein the pivot lock is operable in a locked mode to secure the lock bar in the closed position, and in an unlocked mode to maintain the lock bar in the open position,
whereby the kingpin is removable from the throat to decouple the trailer from the fifth wheel when the lock bar is in the open position.

19. The fifth wheel of claim 18 comprising:
a first biasing member configured to urge the lever in a first direction;
a second biasing member configured to urge the lever in a second direction, opposite the first direction;
an actuator bar including a first end having a handle graspable by a user to move the pivot lock and a second end that is rotatably joined with the pivot lock at an actuator pivot,
wherein the first biasing member is rotatably joined with the pivot lock at the actuator pivot;
wherein the first biasing member is operable in an inactive mode in which the first biasing member ceases urging the lever in the first direction, whereby the second biasing member urges the lever in the second direction, thereby urging the pivot lock second tooth to engage the reset catch to hold the lever in a position and thus maintain the lock bar in the open position.

20. The fifth wheel of claim 18,
wherein the latch plate is disposed forward of an end of the lever,
wherein the pivot lock first tooth extends forward of the pivot lock axis,
wherein the pivot lock first tooth is distal from the lever so that the pivot lock tooth is prevented from directly contacting the lever.
